(19) United States
(12) Patent Application Publication
(10) Pub. No.: US 2026/0016061 A1
(43) Pub. Date: Jan. 15, 2026

(54) BRAKE ASSIST FOR HOLDING TORQUE WITHIN A BRAKE ASSEMBLY

(71) Applicant: Ford Global Technologies, LLC, Dearborn, MI (US)

(72) Inventors: Stuart C. Salter, White Lake, MI (US); Kenneth Patrick Mchugh, Canton, MI (US); Joshua Howell, Belleville, MI (US); Brendan Diamond, Naples, FL (US)

(21) Appl. No.: 18/767,888

(22) Filed: Jul. 9, 2024

(51) Int. Cl. F16D 65/18; F16D 121/20; F16D 125/24; F16D 127/06

(52) U.S. Cl. CPC F16D 65/18; F16D 2121/20; F16D 2125/24; F16D 2127/06

(57) ABSTRACT

A parking brake system of a vehicle may be provided. The parking brake system may include a brake assembly, a controller operably coupled to a sensor suite, and a locking assembly operably coupled to the brake assembly to lock torque applied to the brake assembly when actuated. The locking assembly may include a rack gear that may apply a locking force to a brake pad of the brake assembly when the brake assembly is actuated to apply an actuation force to the rack gear and the vehicle is parked, a solenoid having an energized state and a de-energized state, and a pinion gear operably coupled to the rack gear that may be carried by the rack gear when the brake assembly is actuated. The solenoid may engage the pinion gear when in the energized state and may only release the pinion gear responsive to a reapplication of the actuation force.

### TECHNICAL FIELD

Example embodiments generally relate to brake assembly components and, more particularly, relate to a brake assist for holding torque within a brake assembly.

### BACKGROUND

Steep parking grades, slippery parking surfaces, or inclement weather may cause a parked vehicle to experience a challenging parking environment. In presence of these conditions, vehicle operators may desire increased support for existing parking brakes to ensure expected parking performance. Thus, a brake assist to help hold torque within the brake assembly may be desired.

### BRIEF SUMMARY OF SOME EXAMPLES

In accordance with an example embodiment, a parking brake system of a vehicle may be provided. The parking brake system may include a brake assembly operably coupled to a wheel of the vehicle, a controller operably coupled to a sensor suite for monitoring vehicle conditions and surface conditions, and a locking assembly operably coupled to the brake assembly to lock torque applied to the brake assembly when actuated. The locking assembly may include a rack gear that may apply a locking force to a brake pad of the brake assembly when the brake assembly is actuated to apply an actuation force to the rack gear and the vehicle is parked, a solenoid having an energized state and a de-energized state, and a pinion gear operably coupled to the rack gear that may be carried by the rack gear when the brake assembly is actuated. The solenoid may engage the pinion gear when in the energized state and may only release the pinion gear responsive to a reapplication of the actuation force.

In another example embodiment, a locking assembly of a brake assembly of a vehicle may be provided. The locking assembly may include a rack gear that may apply a locking force to a brake pad of a brake assembly when the brake assembly is actuated to apply an actuation force to the rack gear and the vehicle is parked, a solenoid having an energized state and a de-energized state, and a pinion gear operably coupled to the rack gear that may be carried by the rack gear when the brake assembly is actuated. The solenoid may engage the pinion gear when in the energized state and may only release the pinion gear responsive to a reapplication of the actuation force.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a block diagram of a brake assembly for a vehicle in accordance with an example embodiment;

FIG. 2 illustrates a perspective view of a locking assembly in accordance with an example embodiment;

FIG. 3 depicts a close-up perspective view of a locking assembly in accordance with an example embodiment;

FIG. 4 illustrates a perspective view of a locking assembly in accordance with an example embodiment;

FIG. 5 depicts a close-up perspective view of a locking assembly in accordance with an example embodiment;

FIG. 6 illustrates a perspective view of a locking assembly in accordance with an example embodiment; and

FIG. 7 depicts a close-up perspective view of a locking assembly in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein may address the issues described above. In this regard, for example, some embodiments may provide a parking brake assist to hold braking torque within the brake assembly. As a result, the addition of the parking brake assist may increase brake assembly performance.

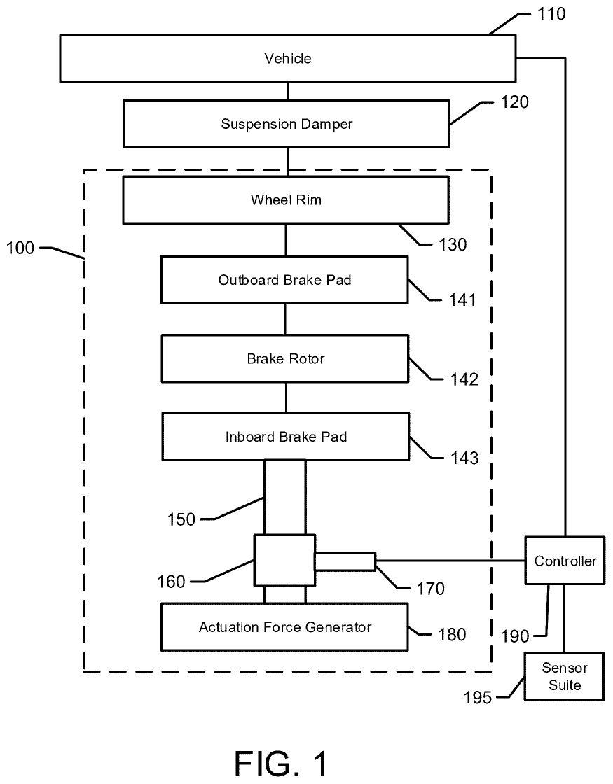

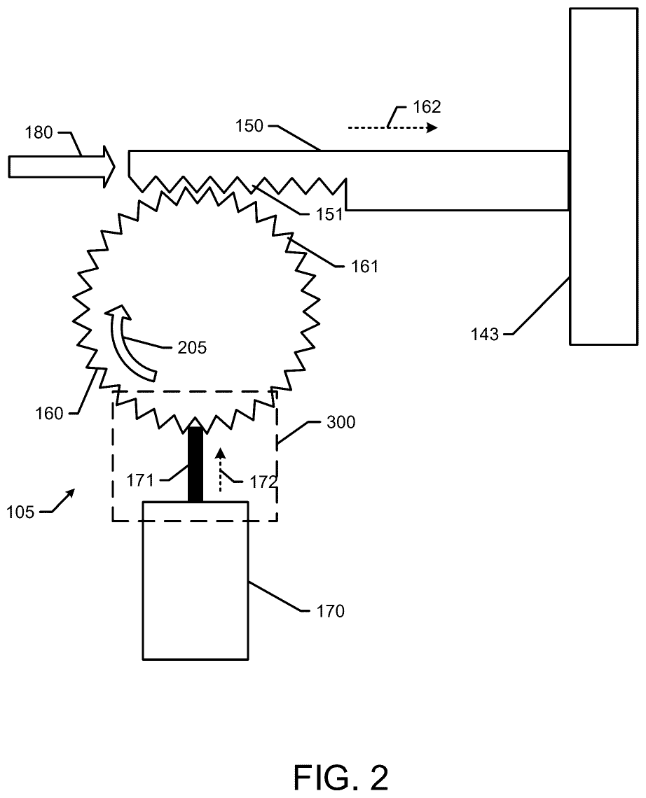

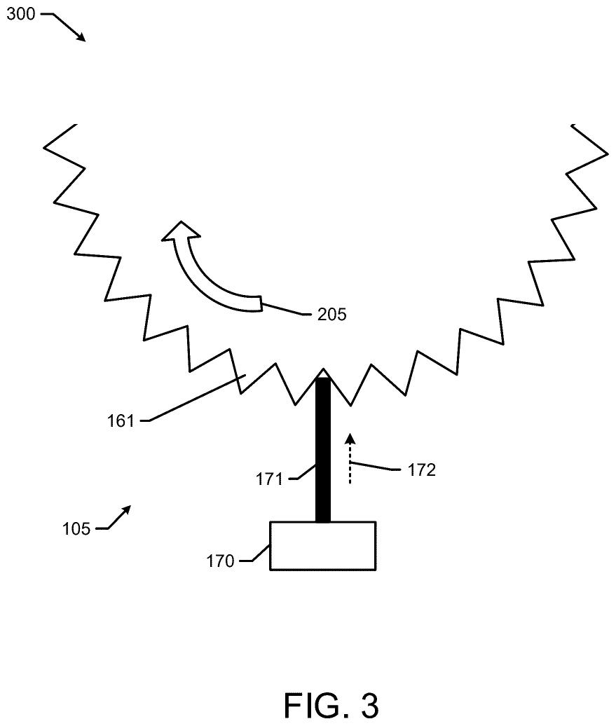

FIG. 1 illustrates a block diagram of a brake assembly 100 for a vehicle 110 in accordance with an example embodiment. FIGS. 2 and 3 illustrates a perspective view of a locking assembly 105 in accordance with an example embodiment. As seen in FIG. 1, in some embodiments, the brake assembly 100 may include a wheel rim 130, an outboard brake pad 141, a brake rotor 142, an inboard brake pad 143, a rack gear 150, a pinion gear 160, a solenoid 170, and an actuation force generator 180. In some cases, the vehicle 110 may include a chassis or frame. The chassis or frame may support and may form the foundation structure of the vehicle 110. In an example embodiment, the chassis and frame may be formed of one or more casted subframes, and a suspension member 120 may be operably coupled to the chassis or frame to help operably couple the brake assembly and/or a wheel assembly to the chassis or frame.

In an example embodiment, the rack gear 150 may apply a locking force to the inboard brake pad 143 to hold the torque within the brake assembly 100. The initial torque is applied to the brake assembly via an actuation force generator 180. The actuation force generator 180 applies braking force to the brake assembly 100 via brake calipers. In some cases, the actuation force generator 180 may be a hydraulic assembly applying a braking force via hydraulic fluid systems operably coupled to the brake calipers. In an example embodiment, the actuation force generator 180 may be part of an electronic braking system or any other vehicle braking system that applies a braking force to slow the vehicle 110 or hold the vehicle 110 when already slowed to a stop.

In an example embodiment, the rack gear 150 may track or move synchronously with brake caliper piston or pad movement. Thus, due to the synchronous movement of the rack gear 150 and with the brake calipers, the actuation force generator 180 may apply an actuation force 181 to the rack gear 150. The actuation force 181 may enable the rack gear 150 to apply a locking force 162 to the inboard brake pad 143 in order to help maintain and lock the brake force applied by the actuation force generator 180 when the brake assembly 100 is not actuated.

In some cases, to enable the rack gear 150 to maintain the brake force applied by the actuation force generator 180, the locking assembly 105 may include the pinion gear 160 and the solenoid 170. In an example embodiment, the pinion gear 160 may be a circular gear with pinion gear teeth 161 surrounding its outer circumference. In some cases, the pinion gear teeth 161 may engage with rack gear teeth 151 to synchronize the movement of the pinion gear 160 and the rack gear 150. The engagement of the pinion gear teeth 161 with rack gear teeth 151 may be the source for the first pinion gear rotational force 205. In an example embodiment, movement of the pinion gear 160 may thus be synchronized with the movement of the brake calipers, as movement of the rack gear 150 may be synchronized with both the movement of the pinion gear 160 and the brake calipers. The pinion gear 160 may not be limited to a circular shape and may be any number of shapes or systems that maintain the pinion gear 160 function.

In an example embodiment, a solenoid 170 may be included in the locking assembly 105 for the brake assembly. The solenoid 170 may include a pin 171. The pin 171 of the solenoid 170 may be biased towards or away from the pinion gear 160 depending on the type of the solenoid 170. In an example embodiment, the solenoid 170 may be a spring solenoid, and the pin 171 may be biased based on an internal spring of the solenoid. In some cases, the solenoid 170 may be any number of types of solenoids, including but not limited to magnetic solenoids, fully electronic solenoids, rotary solenoids, or valve-based solenoids.

In some cases, the solenoid 170 may have an energized state and a de-energized state. The energized state may extend the pin 171 towards the pinion gear 160, and the de-energized state may only utilize the pre-set bias of the solenoid 170 (i.e. away from the pinion gear 160) to adjust the pin 171. For example, responsive to the solenoid 170 transitioning to an energized state, the pin 171 may extend towards the pinion gear 160 and engage between the pinion gear teeth 161. The engagement of the pin 171 between the pinion gear teeth 161 may lock the pinion gear 160 in place. In an example embodiment, locking the pinion gear 160 in place may thus lock the rack gear 150 in place to hold the torque applied to the inboard brake pad 143. In some cases, the solenoid 170 may switch between an energized state and a de-energized state based on a current (I) threshold being reached.

In an example embodiment, the pin 171 of the solenoid 170 may engage substantially perpendicular to the surface of the pinion gear 160. The surface of the pinion gear 160 may be the surface between the pinion gear teeth 161. In some cases, the pin 171 of the solenoid 170 may engage substantially parallel to the surface of the pinion gear 160. For example, the pin 171 may engage sideways between the pinion gear teeth 161 rather than extending along a longitudinal length of the pinion gear teeth 161.

In an example embodiment, a controller 190 may be operably coupled to the brake assembly 100 and the vehicle 110. In some cases, the controller 190 may be operably coupled to a sensor suite 195. The sensor suite 195 may include a plurality of different sensors monitoring vehicle conditions and surface conditions around the vehicle 110. The vehicle conditions may be monitored by the sensor suite 195 via wheel sensors, external cameras/radars monitoring vehicle movement, vehicle attachment sensors (i.e. trailer attachment sensor), brake temperature sensors, or any number of sensors that help to determine the vehicle conditions. The surface conditions may be the current or estimated future conditions of the surface where the vehicle is parked. Surface conditions may be monitored by the sensor suite 195 via temperature sensors, parking grade estimators, location/GPS sensors, external weather reports, external cameras monitoring the surface, or any number of sensors that help to determine the surface conditions.

In an example embodiment, the controller 190 may include one or more controllers. The controller 190 may include processing circuitry that includes a processor and memory. The processing circuitry may be configured to provide electronic control of the inputs to one or more functional units of the brake assembly 100 and to process data received at or generated by the one or more functional units of the vehicle control system. Thus, the processing circuitry may be configured to perform data processing, control function execution and/or other processing and management services according to an example embodiment. In some embodiments, the processing circuitry may be embodied as a chip or chip set. In other words, the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry may therefore, in some cases, be configured to implement an embodiment of the present invention on a single chip or as a single “system on a chip.” As such, in some cases, a chip or chipset may constitute means for performing one or more operations for providing the functionalities described herein. In an example embodiment, other vehicle control modules may include similar processing circuitry.

In some cases, the controller 190 may be operably coupled directly to the solenoid 170 and may determine whether the solenoid 170 should be in the energized state or the de-energized state. The determination of the supposed state of the solenoid 170 may be determined based on the measurements and results of the sensor suite 195. In some cases, the controller 190 may be communicatively operably coupled to the solenoid 170, as well as other components of the brake assembly 100 and the vehicle.

In an example embodiment, the controller 190 may determine if the vehicle 110 is parked. The controller 190 may determine the vehicle 110 is parked via the sensor suite 195 or other control systems or sensors within the vehicle 110. Responsive to determining the vehicle 110 is parked and the actuation force generator 180 is actively applying the actuation force 181 to the rack gear 150, the controller 190 may energize the solenoid 170 to an energized state to have the pin 171 engage with the pinion gear 160 based on determined vehicle movement or environment conditions. In the energized state, the solenoid 170 may exert an anti-bias force 172 on the pin 171. In this example embodiment, the solenoid is in a locked position and further locks the pinion gear 160 and rack gear 150 in position to hold the torque within the brake assembly 100.

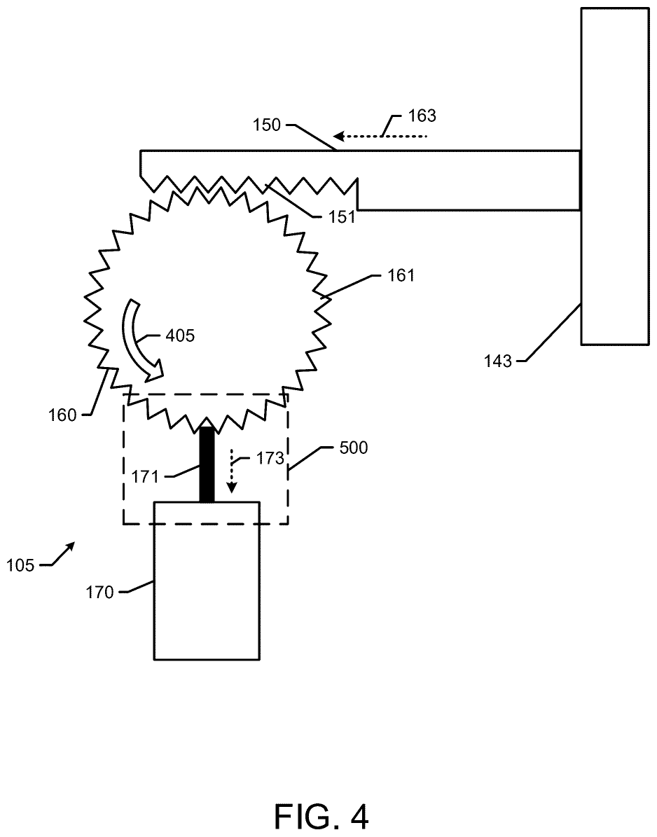

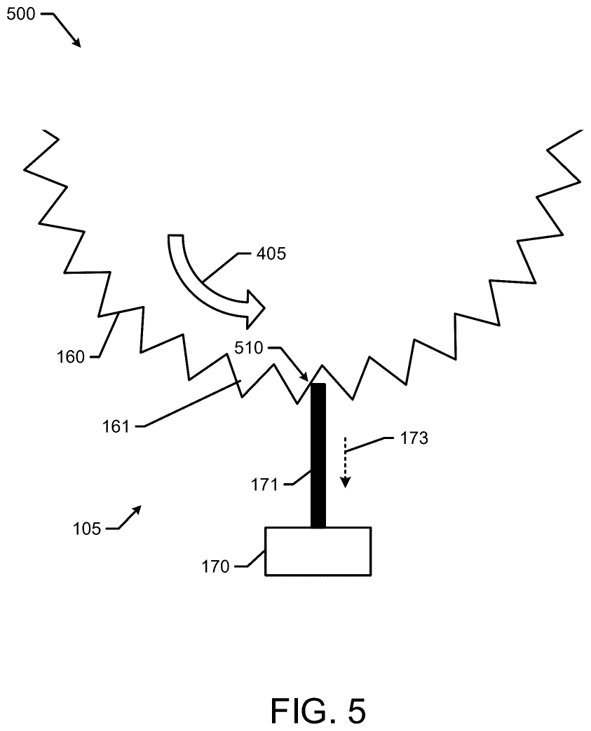

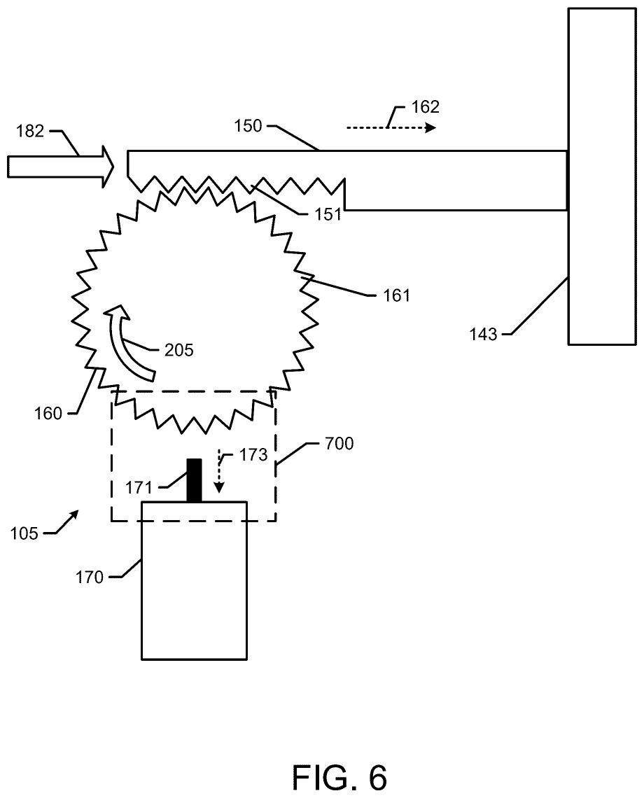

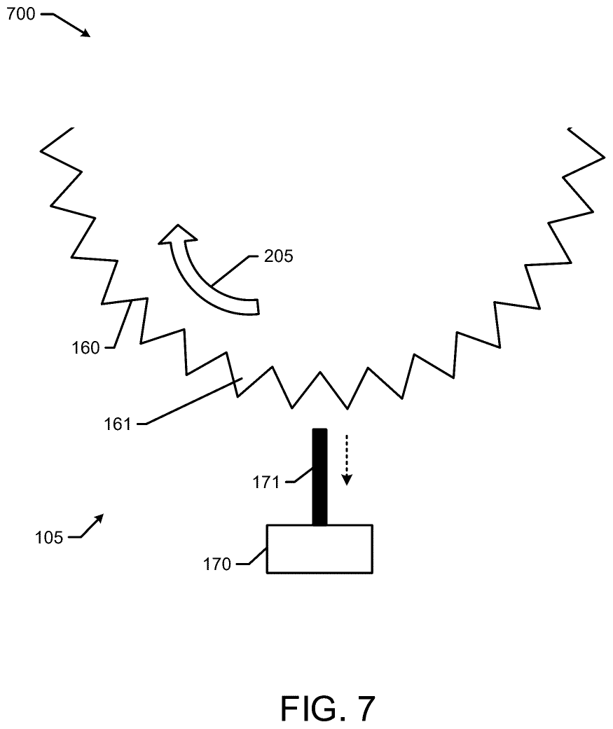

FIGS. 4-7 illustrate a further perspective views of a locking assembly 105 in accordance with an example embodiment. As seen in FIGS. 4 and 5, the pinion gear 160 and rack gear 150 have maintain their positions in the absence of the actuation force 181 being applied to the rack gear 150 by the actuation force generator 180. In some cases, responsive to the pinion gear 160 and the solenoid 170 being in a locked position, the solenoid 170 may be in a de-energized state and still substantially maintain the positions of the rack gear 150 and the pinion gear 160 without the actuation force 181 being applied to the rack gear 150 by the actuation force generator 180. The pin 171 of the solenoid 170 may maintain the pin's locked position while the solenoid 170 is in the de-energized state due to a second pinion gear rotational force 405 applying to the pin 171. The second pinion gear rotational force 405 may be generated by the relaxation force 163 of the rack gear 150 no longer being under the application of the actuation force 181. The relaxation force 163 may not completely remove the locking force 162, as the locking force 162 may still hold the required brake torque. The second pinion gear rotational force 405 thus may also be caused via the engagement of the pinion gear teeth 161 with rack gear teeth 151.

As illustrated explicitly in the close-up perspective of FIG. 5 in accordance with an example embodiment, the second pinion gear rotational force 405 applies a tangential force to the pin 171 at an intersection 510 of the pin 171 and a tooth of the pinion gear teeth 161. The tangential force applied to the intersection 510 locks the pin 171 in place, despite a solenoid biasing force 173 attempting to pull the pin 171 away from the pinion gear 160. In some cases, the solenoid biasing force 173 may be a retraction force caused by a spring of the solenoid 170. In an example embodiment, the solenoid 170 may be a spring solenoid that electrically extends the pin 171 towards the pinion gear 160 when energized and includes a spring that exerts the solenoid biasing force 173 on the pin 171 to retract the pin 171 away from the pinion gear 160 when de-energized. In some cases, the solenoid 170 may be any number of solenoid types to enable the locking assembly 105 function. Thus, the solenoid 170 and the pin 171 may be in a locked position while in the de-energized state without the actuation force 181 being applied to the rack gear 150.

In an example embodiment, the solenoid 170 may only release the pinion gear 160 upon a reapplication of the actuation force 182 from the actuation force generator 180. The reapplication of the actuation force 182 may apply to the rack gear 150 to generate the locking force 162 and the first pinion gear rotational force 205. In some cases, the solenoid 170 may be in the de-energized state responsive to the initial lack of the actuation force 181 being applied to the rack gear 150. Thus, for example upon the reapplication of the actuation force 182, the first pinion gear rotational force 205 may release the tangential force applied on the pin 171 and may allow the pin to retract away from the pinion gear 160 due to the solenoid biasing force 173. The retraction of the pin 171 may allow the pinion gear 160 to fully release, and the vehicle 110 may leave a parked state.

In some cases, the controller 190 may selectively energize the solenoid based on the vehicle conditions and the surface conditions. The controller 190 may preemptively energize the solenoid 170 based on the vehicle conditions and the surface conditions or may initially energize the solenoid 170 based on a change in the vehicle conditions and the surface conditions. In an example embodiment, the surface conditions may be determined via a variety of measurements collected via the sensor suite 195 and/or historical data. Historical data may be collected from various databases or may be locally stored data of the vehicle. For example, locally stored data of the vehicle may be previously stored measurements from the sensor suite 195. The variety of measurements collected via the sensor suite 195 may include real time surface coefficient of friction (u) measurements and inclination/grade measurements. In an example embodiment, the u measurements of the surface may be compared the inclination/grade measurements to determine if there is increased likelihood over a threshold of the vehicle 110 slipping while parked. If the likelihood of the vehicle 110 slipping while parked crosses the threshold, the controller 190 may energize the solenoid 170 to help lock the parking brake torque.

In some cases, the sensor suite 195 may further identify potentially slippery surfaces. In an example embodiment, the sensor suite 195 may include a camera that may identify if the vehicle 110 is being parked on snow, ice, or other slippery surfaces (i.e. pooled water, etc.). Responsive to determining the vehicle 110 is parked on snow, ice, or other slippery surfaces via the camera or other sensors within the sensor suite, the controller 190 may energize the solenoid 170 to help lock the parking brake torque. The sensor suite 195 may include temperature sensors to measure ambient temperature around the vehicle 110 to assist in surface condition determination. In some cases, the sensor suite 195 may determine if the vehicle is parked in a covered or uncovered area. The determination of if the vehicle is parked in a covered or uncovered area may be combined with other determined surface information or weather forecasts by the controller 190 to determine if the solenoid 170 should be energized.

In some cases, weather forecasts may be taken provided to vehicle 110 from third-party services or via a subscription service provided by the vehicle manufacturer. Historical data may also be provided to the vehicle 110 from third-party services or via a subscription service provided by the vehicle manufacturer.

In an example embodiment, the controller 190 may monitor vehicle conditions help in the determination of whether to energize the solenoid 170 to help lock the parking brake torque. In some cases, the sensor suite 195 may assist in monitoring the vehicle conditions. In an example embodiment, the controller 190 may receive information on which vehicle modes are engaged by the operator. In some cases, the controller 190 may communicate with the sensor suite 195 to determine if a trailer is connected, thus increasing net vehicle weight. The controller 190 may also monitor anti-lock braking system (ABS) and electronic stability control (ESC) events to help determine if the solenoid 170 should be energized.

In an example embodiment, the sensor suite 195 may include wheel speed sensors, ultra-wide band radars, and brake temperature sensors. In some cases, the combination of measurements from the sensor suite 195 may be used to determine if the vehicle 110 has begun to move while parked. For example, the ultra-wide band radars may be used to detect vehicle movement relative to the surroundings and may allow the controller 190 to energize the solenoid 170 responsive to ultra-wide band radar determinations. Wheel speed sensors and brake temperature sensors may be used alone or in combination by the controller 190 to help determine vehicle movement.

In an example embodiment, the controller 190 may lock the torque of the brake assembly 100 via an alternative hydraulic lock. For example, a bi-stable solenoid driven valve may lock in a hydraulic holding torque by closing the hydraulic fluid lines after the vehicle 110 is determined to be stationary or parked. In some cases, steep parking grades, slippery parking surfaces, or inclement weather may affect the vehicle 100. Thus, in the case of specific vehicle and environment conditions, a brake assist to help hold torque within the brake assembly may be desired.

A parking brake system of a vehicle may therefore be provided. The parking brake system may include a brake assembly operably coupled to a wheel of the vehicle, a controller operably coupled to a sensor suite for monitoring vehicle conditions and surface conditions, and a locking assembly operably coupled to the brake assembly to lock torque applied to the brake assembly when actuated. The locking assembly may include a rack gear that may apply a locking force to a brake pad of the brake assembly when the brake assembly is actuated to apply an actuation force to the rack gear and the vehicle is parked, a solenoid having an energized state and a de-energized state, and a pinion gear operably coupled to the rack gear that may be carried by the rack gear when the brake assembly is actuated. The solenoid may engage the pinion gear when in the energized state and may only release the pinion gear responsive to a reapplication of the actuation force.

The parking brake system of a vehicle of some embodiments may include additional features, modifications, augmentations and/or the like to achieve further objectives or enhance performance of the suspension assembly. The additional features, modifications, augmentations and/or the like may be added in any combination with each other. Below is a list of various additional features, modifications, and augmentations that can each be added individually or in any combination with each other. For example, the solenoid may be in a locked position responsive to being in the energized state and the de-energized state without the actuation force being applied. In an example embodiment, the pinion gear may be locked by a pin of the solenoid operably coupling between teeth of the pinion gear responsive to the solenoid being in a locked position. In some cases, the pin of the solenoid may be operably coupled between the teeth of the pinion gear substantially parallel or substantially perpendicular to a surface of the pinion gear. In an example embodiment, the pin of the solenoid may maintain the pin's current position responsive to the solenoid being de-energized due to a rotational force of the pinion gear applying to the pin of the solenoid. In some cases, a lack of application of the actuation force to the rack gear may generate the rotational force of the pinion gear. In an example embodiment, responsive to the rack gear reapplying the locking force to the brake pad of the brake assembly upon reapplication of the actuation force to the rack gear and the pin of the solenoid being in the locked position operably coupled to the pinion gear while the solenoid is de-energized, the pin of the solenoid may be unlocked and returns to an original biased state. In some cases, the solenoid may be a spring solenoid biased away from the pinion gear. In an example embodiment, the solenoid may be initially energized based on a determination of vehicle motion by a sensor suite of the vehicle. In some cases, the solenoid may be preemptively energized before vehicle motion based on a determination of a vehicle's surroundings by a sensor suite of the vehicle. In an example embodiment, the determination of vehicle's surroundings may include the vehicle conditions, a parking grade estimation, a weather report, or the surface conditions.

A locking assembly of a brake assembly of a vehicle of an example embodiment may therefore be provided. The locking assembly may include a rack gear that may apply a locking force to a brake pad of a brake assembly when the brake assembly is actuated to apply an actuation force to the rack gear and the vehicle is parked, a solenoid having an energized state and a de-energized state, and a pinion gear operably coupled to the rack gear that may be carried by the rack gear when the brake assembly is actuated. The solenoid may engage the pinion gear when in the energized state and may only release the pinion gear responsive to a reapplication of the actuation force.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A parking brake system of a vehicle, the parking brake system comprising:
a brake assembly operably coupled to a wheel of the vehicle;
a controller operably coupled to a sensor suite for monitoring vehicle conditions and surface conditions; and
a locking assembly operably coupled to the brake assembly to lock torque applied to the brake assembly when actuated, the locking assembly comprising:
a rack gear that applies a locking force to a brake pad of the brake assembly when the brake assembly is actuated to apply an actuation force to the rack gear and the vehicle is parked;
a solenoid having an energized state and a de-energized state; and
a pinion gear operably coupled to the rack gear and carried by the rack gear when the brake assembly is actuated,
wherein the solenoid engages the pinion gear when in the energized state and only releases the pinion gear responsive to a reapplication of the actuation force.

2. The parking brake system of claim 1, wherein the solenoid is in a locked position responsive to being in the energized state and the de-energized state without the actuation force being applied.

3. The parking brake system of claim 2, wherein the pinion gear is locked by a pin of the solenoid operably coupling between teeth of the pinion gear responsive to the solenoid being in a locked position.

4. The parking brake system of claim 3, wherein the pin of the solenoid operably coupled between the teeth of the pinion gear substantially parallel or substantially perpendicular to a surface of the pinion gear.

5. The parking brake system of claim 3, wherein the pin of the solenoid maintains the pin's current position responsive to the solenoid being de-energized due to a rotational force of the pinion gear applying to the pin of the solenoid.

6. The parking brake system of claim 5, wherein a lack of application of the actuation force to the rack gear generates the rotational force of the pinion gear.

7. The parking brake system of claim 6, wherein responsive to the rack gear reapplying the locking force to the brake pad of the brake assembly upon reapplication of the actuation force to the rack gear and the pin of the solenoid being in the locked position operably coupled to the pinion gear while the solenoid is de-energized, the pin of the solenoid is unlocked and returns to an original biased state.

8. The parking brake system of claim 7, wherein the solenoid is a spring solenoid biased away from the pinion gear.

9. The parking brake system of claim 1, wherein the solenoid is initially energized based on a determination of vehicle motion by a sensor suite of the vehicle.

10. The parking brake system of claim 1, wherein the solenoid is preemptively energized before vehicle motion based on a determination of a vehicle's surroundings by a sensor suite of the vehicle.

11. The parking brake system of claim 10, wherein the determination of vehicle's surroundings includes the vehicle conditions, a parking grade estimation, a weather report, or the surface conditions.

12. A locking assembly of a brake assembly of a vehicle, the locking assembly comprising:
a rack gear that applies a locking force to a brake pad of a brake assembly when the brake assembly is actuated to apply an actuation force to the rack gear and the vehicle is parked;
a solenoid having an energized state and a de-energized state; and
a pinion gear operably coupled to the rack gear and carried by the rack gear when the brake assembly is actuated,
wherein the solenoid engages the pinion gear when in the energized state and only releases the pinion gear responsive to a reapplication of the actuation force.

13. The locking assembly of claim 12, wherein the solenoid is in a locked position responsive to being in the energized state and the de-energized state without the actuation force being applied.

14. The locking assembly of claim 13, wherein the pinion gear is locked by a pin of the solenoid operably coupling between teeth of the pinion gear responsive to the solenoid being in a locked position.

15. The locking assembly of claim 14, wherein the pin of the solenoid operably coupled between the teeth of the pinion gear substantially parallel or substantially perpendicular to a surface of the pinion gear.

16. The locking assembly of claim 14, wherein the pin of the solenoid maintains the pin's current position responsive to the solenoid being de-energized due to a rotational force of the pinion gear applying to the pin of the solenoid.

17. The locking assembly of claim 16, wherein a lack of application of the actuation force to the rack gear generates the rotational force of the pinion gear.

18. The locking assembly of claim 17, wherein responsive to the rack gear reapplying the locking force to the brake pad of the brake assembly upon reapplication of the actuation force to the rack gear and the pin of the solenoid being in the locked position operably coupled to the pinion gear while the solenoid is de-energized, the pin of the solenoid is unlocked and returns to an original biased state.

19. The locking assembly of claim 18, wherein the solenoid is a spring solenoid biased away from the pinion gear.

20. The locking assembly of claim 12, wherein the solenoid is initially energized by a controller based on a determination of vehicle motion by a sensor suite of the vehicle, or
wherein the solenoid is preemptively energized by the controller before vehicle motion based on a determination of a vehicle's surroundings by a sensor suite of the vehicle.
